(19) United States
(12) Patent Application Publication
(10) Pub. No.: US 2004/0242754 A1
(43) Pub. Date: Dec. 2, 2004

(54) Process for the preparation of composite polymeric particles in emulsion

(76) Inventors: Francesco Masi, Sant'Angelo Lodigiano-Lodi (IT); Roma Lima, Godo-Ravenna (IT); Piero Maestri, Forlimpopoli-Forli' (IT)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/484,801

(22) PCT Filed: Jul. 26, 2002
(86) PCT No.: PCT/EP02/08455

(30) Foreign Application Priority Data
Aug. 2, 2001 (IT) MI2001A001687

(51) Int. Cl. C08F 2/16

(52) U.S. Cl. 524/458

(57) ABSTRACT

A process is described for producing aqueous latexes essentially consisting of composite polymeric particles which comprises: (a) a first radicalic polymerization step in aqueous emulsion of monomers selected from vinylaromatics and mixtures of vinylaromatics/conjugated dienes, thus obtaining the first latex; (b) a second radicalic polymerization step in aqueous emulsion which consists in polymerizing, on the latex obtained in step (a), chloroprene or mixtures of chloroprene and monomers copolymerizable with chloroprene, the latter in a quantity not higher than 10% by weight with respect to the chloroprene, thus obtaining the latex object of the present invention.

The present invention relates to a process for producing aqueous latexes essentially consisting of composite polymeric particles, which comprises:

(a) a first radicalic polymerization step in aqueous emulsion of monomers selected from vinylaromatics and mixtures of vinylaromatics/conjugated dienes, thus obtaining the first latex;

(b) a second radicalic polymerization step in aqueous emulsion which consists in polymerizing, on the latex obtained in step (a), chloroprene or mixtures of chloroprene and monomers copolymerizable with chloroprene, the latter in a quantity not higher than 10% by weight with respect to the chloroprene, thus obtaining the latex object of the present invention.

Polychloroprene (CR) is a special rubber mainly consisting of the homopolymer of chloroprene, its properties are:

resistance to gasolines, ozone and aging;

flexibility at low temperatures;

good adhesion;

tensile and elasticity properties after vulcanization; flame resistance

and therefore with a wide range of applications both as a rubber and as latex. In particular, it is used in the production of rubber articles, cables, glues and adhesives.

CR has the tendency of crystallizing; this leads to an increase in the viscosity of the raw compounds and hardness of the vulcanized products.

The crystallization rate can be attenuated by reducing the content of the 1,4-trans configuration. This can be obtained with a higher polymerization temperature (increasing however the 1,4-trans configuration and 1,2- and 3,4-structures) or by inserting a comonomer.

The behaviour of chloroprene in homo- and copolymerizations has been described in detail by Obrecht [W. Obrecht, Houben Weyl, E 20 II (1987) 842]. New monomers have recently been found, capable of copolymerizing with chloroprene and therefore capable of modifying its properties, such as, for example, polyether acrylates and methacrylates (U.S. Pat. No. 4,957,991) and alpha cyanoacrylates (U.S. Pat. No. 5,824,758). These however are not industrially available.

Among industrially available comonomers, those have a greater reactivity of chloroprene are 2,3-dichloro 1,3-butadiene (r₁=0.355, r₂=2.15±0.25 at 40° C.) and sulfur [Vinyl and Diene Monomers, Wiley Interscience 1971].

Other modifications of the properties of CR, by the insertion of different comonomers from those mentioned above, are difficult. Only a few vinyl monomers are used on an industrial scale and in most cases there is mainly the homopolymerization of chloroprene.

Copolymers with methacrylic acid however are obtained using particular expedients, such as:

polymerization at pH 2÷4

polymerization technology in semi-continuous.

In the first case natural soaps (for example resinic acid) cannot be used and consequently certain taking levels are not reached.

In the second case the formation of gel cannot be avoided as most of the polymer is generated with a high conversion.

On the other hand, it is known in the art that some improvements can be obtained by means of mixtures of rubbers obtained both from latex cuts and by dry blends (see for example U.S. Pat. No. 4,895,906 and U.S. Pat. No. 3,943,192).

The direct use of mechanical mixtures of CR and NBR latexes in the production of rubber articles is also described (patent WO 99/24507).

A process has now been found, which leads to the production of a new latex with improved performances.

In according with this, the present invention relates to a process for producing aqueous latexes which comprises:

a) a first radicalic polymerization step in aqueous emulsion of a polymerizable composition essentially consisting of vinylaromatic monomers or mixtures of vinylaromatics/conjugated dienes, preferably styrene or styrene/conjugated diene mixtures, even more preferably styrene or styrene/butadiene mixtures, thus obtaining a first latex;

(b) a second radicalic polymerization step in aqueous emulsion which consists in polymerizing, on the latex obtained in step (a), chloroprene or mixtures of chloroprene and monomers copolymerizable with chloroprene, the latter in a quantity not higher than 10% by weight with respect to the chloroprene, thus obtaining the latex object of the present invention.

In the even more preferred embodiment, in step (a) the polymerization of a styrene-butadiene mixture is effected, in which the styrene varies from 100% by weight to 30% by weight.

At the end of the process of the present invention, latexes are obtained with composite particles in which the chloroprene is bound, partly physically, partly chemically, to other monomers in polymeric form.

The latex obtained at the end of step (a) consists of polymeric particles deriving from the homopolymerization of vinylaromatic compounds or the copolymerization of these with conjugated dienes.

Typical examples of vinylaromatic compounds are styrene, α-methyl styrene, β-methyl styrene, 4-methylstyrene. Typical examples of conjugated dienes are 1,3-butadiene and isoprene.

Again in step (a), chloroprene can also be used as comonomer, mixed with the above monomers in a ratio ranging from 0% to 15% by weight, preferably from 0% to 10% by weight, of the total of monomers used.

The second step of the process of the present invention consists in polymerizing, on the latex obtained in step (a), chloroprene or mixtures of chloroprene and monomers copolymerizable with chloroprene, the latter in a quantity not higher than 10% by weight with respect to the chloroprene, thus obtaining the latex object of the present invention.

In step (a), the polymerization can be carried out in the presence of either ionic or non-ionic emulsifying agents, or a mixture of both, at temperatures ranging from 5° C. to 120° C., preferably from 10° C. to 90° C., in an acid, neutral or basic aqueous medium. The pH can be regulated with the addition of a mineral acid or non-polymerizable organic acids soluble in water such as acetic acid, the system can be buffered to prevent a shift in the pH during the reaction with sodium phosphate or carbonate. The polymerization is started by radicals which can be generated either by the thermal decomposition of peroxides or diazo-compounds or by oxide-reduction reaction (redox pair).

The initiator system used for the polymerization comprises: salts soluble in water of peroxydisulfuric acid such as sodium, potassium and ammonium, organic peroxides such as diisopropyl benzene hydroperoxide, tertiary butyl hydroperoxide, pinane hydroperoxide and preferably redox systems. Examples of redox systems include the combination of sodium peroxydisulfate/sodium dithionite, diisopropyl benzene hydroperoxide/sulfoxylated sodium formaldehyde; other redox systems use bivalent iron as reducing agent combined with auxiliary reducing agents (sulfoxylated sodium formaldehyde).

Emulsifying agents which can be used are both anionic and non-ionic; the former can be alkyl aryl sulfonates containing up to 18 carbon atoms in the alkyl chain, alkyl sulfates and alkyl sulfonates, condensation products of formaldehyde with naphthalene sulfonic acid, sodium and potassium salts of resinic acids, oleic acid and fatty acids. The non-ionic emulsifying agents used are condensation products of ethylene and propylene oxide with alkyl phenols.

The polymerization is carried out in the presence of molecular weight regulators to regulate both the gel and the molecular weight of the polymer itself without significantly altering the polymerization kinetics. The molecular weight regulators which can be used are: dialkyl xanthogen disulfides containing linear or branched alkyl chains such as methyl, ethyl, propyl, isopropyl, butyl, hexyl, heptyl, octyl; alkyl mercaptans containing from 4 to 20 carbon atoms in the alkyl chain, primary, secondary, tertiary and branched such as butyl, hexyl, octyl, dodecyl, tridecyl mercaptans and the relative mixtures. The conversions at the end of step (a) range from 60% up to 100% and, preferably, from 70% to 99%, obtaining final solids ranging from 5% to 60% by weight, preferably from 30% to 50% by weight. The polymerization can be interrupted by the addition of a polymerization inhibitor such as phenothiazine, hydroxylamine sulfate, sodium tetrasulfide, sodium polysulfide mixed with mono-isopropyl hydroxylamine. The residual monomers can be removed or left and used in the second polymerization step. The optional removal can be carried out with stripping in a stream of vapour in a column. The gel content of the polymer can range from 0% to 90% by weight and can be regulated using suitable quantities of chain transfer agents, polymerization temperatures, conversion and divinylbenzene as cross-linking agent. The gel content is the percentage of polymer insoluble in tetrahydrofuran at 25° C. This is determined by dissolving 1 g of polymer in 100 ml of tetrahydrofuran under stirring for 24 hours; the insoluble polymer is cascade filtered at 325 mesh (macrogel) and 0.2 microns (microgel) and dried at 70° C. until a constant weight is reached. The polymerization can be carried out in continuous, batchwise or in semi-continuous; as far as the polymerization procedure is concerned, reference should be made to what is known in literature [High polymer Latexes, D. C. Blackley, vol.1, page 261 (1966); Encyclopedia of polymer Science and Technology]. The average particle dimensions of the polymer obtained in this first step can range from 1 nm to 1000 nm and, preferably from 5 nm to 500 nm, and are regulated by varying the polymerization temperature, the types and quantities of surface-active agents, the ratio of the latter with the monomeric mixture, the type and quantity of polymerization initiator. The measurement of the average particle dimensions is effected with Coulter N4 after suitable dilution of the sample. The polymeric emulsion obtained in this first polymerization step can be prepared in the same reactor used for the subsequent polymerization of the second step, or in different reactors.

The present invention also comprises the possibility of using in the first step a preformed polymeric emulsion of the corresponding (co)polymers, provided they have the particle dimensions according to the present invention.

Step (b) consists in polymerizing, on the latex obtained in step (a), a monomeric mixture containing chloroprene as main monomer. In this step, from 0% to 10% by weight, with respect to the chloroprene monomer, of one or more mono and diethylene unsaturated monomers can be present, such as 1,3-butadiene, styrene, acrylonitrile; α-β unsaturated acids corresponding to the following formula CH₂=C(R)—COOH with R=H, Cl-4 alkyl or CH₂COOH; acrylamide, vinyl acetate, isoprene, 2,3-dichloro-1,3-butadiene, 1-chloro-1,3-butadiene, vinyl chloride, Cl-4 alkyl acrylates, Cl-4 alkyl methacrylates, sulfur, divinylbenzene. The comonomers are preferably selected from 1,3-butadiene, styrene, acrylonitrile, acrylic acid, methacrylic acid, butyl acrylate, methyl methacrylate, sulfur, 2,3-dichloro-1,3-butadiene. The polymerization can be carried out in the presence of or without emulsifying agents, either ionic or non-ionic, or a mixture of both, at temperatures ranging from 5° C. to 100° C. and preferably from 5° C. to 60° C., in an acid, neutral or basic aqueous medium. The pH can be regulated with the addition of mineral acid or non-polymerizable organic acids soluble in water such as acetic acid. It is preferable to buffer the system (for example with sodium carbonate or phosphate) to avoid a shift in the pH during the reaction. The polymerization is initiated by radicals which can be generated either by the thermal decomposition of peroxides and diazo-compounds or by oxide-reduction (redox pair).

The initiator system used for the polymerization comprises: salts soluble in water of peroxydisulfuric acid such as sodium, potassium and ammonium, organic peroxides such as diisopropyl benzene hydroperoxide, tertiary butyl hydroperoxide, pinane hydroperoxide and preferably redox systems. Examples of redox systems include the combination of sodium peroxydisulfate/sodium dithionite, diisopropyl benzene hydroperoxide/sulfoxylated sodium formaldehyde. Other redox systems use bivalent iron as reducing agent combined with auxiliary reducing agents (sulfoxylated sodium formaldehyde).

Emulsifying agents which can be used are both anionic and non-ionic; the former can be alkyl aryl sulfonates containing up to 18 carbon atoms in the alkyl chain, alkyl sulfates and alkyl sulfonates, condensation products of formaldehyde with naphthalene sulfonic acid, sodium and potassium salts of resinic acids, oleic acid and fatty acids. The non-ionic emulsifying agents used are condensation products of ethylene and propylene oxide with alkyl phenols.

The polymerization is carried out in the presence of molecular weight regulators to regulate both the gel and the molecular weight of the polymer itself without significantly altering the polymerization kinetics. The molecular weight regulators which can be used are: dialkyl xanthogen disulfides containing linear or branched alkyl chains such as methyl, ethyl, propyl, isopropyl, butyl, hexyl, heptyl, octyl; alkyl mercaptans containing from 4 to 20 carbon atoms in the alkyl chain, primary, secondary, tertiary and branched such as butyl, hexyl, octyl, dodecyl, tridecyl mercaptans and the relative mixtures. The final conversions range from 60% up to 100% and, preferably, from 70% to 99%. The final content of solids ranges from 25% to 65% by weight, preferably from 45% to 60% by weight. The polymerization can be interrupted by the addition of a polymerization inhibitor such as phenothiazine, hydroxylamine sulfate, sodium tetrasulfide, sodium polysulfide mixed with mono-isopropyl hydroxylamine. At the end of the polymerization, any possible residual monomers can be removed by stripping in a stream of vapour in a column. The following products can be added to the final composite latex thus obtained: ionic and/or non-ionic surface-active agents, aqueous solutions of potassium, sodium or ammonium hydroxide in order to stabilize the aqueous dispersion towards coagulation. Furthermore, in order to prevent the deterioration of the polymeric substrate towards oxidation, antioxidants can be added in a quantity of 0.1% to 5% by weight with respect to the weight of the polymer. The commonest antioxidants which can be used are of the phenol or amine type.

The gel content of the composite polymer can range from 5% to 90% by weight and depends on the type of polymer obtained in step (a). The above gel content can be further regulated using suitable quantities of chain transfer agents, polymerization temperatures and conversion. The average dimensions of the end polymeric particles can range from 50 nm to 1500 nm and are regulated by the particle dimensions obtained during step (a) and the polymerization technology used for this second step; the latter in fact can be carried out either batchwise or in a semi-continuous process.

Assuming that the total monomers polymerized in the two steps are equal to 100, the ratio between the monomers polymerized in step (a) with respect to the monomers polymerized in step (b) ranges from 5/95 to 50/50, preferably from 7/93 to 20/80.

The emulsions thus obtained can be used as raw material in the adhesive and glue sector, in textile and cellulose impregnation, foams, dipping, bitumen and cement modification and in coating in general or as rubber obtained from the latex in the tyre industry, air springs, plastic material modifiers and other rubber articles.

The use of styrene or a high-styrene SBR copolymer (styrene-butadiene) as latex on which the chloroprene monomer can be polymerized, has been found to be very interesting. The end polymer obtained has. extremely interesting performances in applicative fields (adhesives, shoes, etc.) where it is important to increase the rigidity, mechanical resistance, thermal holding temperature of the polychloroprene, without renouncing its properties; it has been surprisingly found that chloroprene polymerized on a preformed latex does not lose any of its crystallinity or crystallization rate.

In the applicative field of reinforcements for footwear, polychloroprene latexes with a medium and high crystallization rate, are normally used. In this type of application, it is important for the end-product, prevalently consisting of cotton felt impregnated with the polychloroprene latex, to have a good hot processability (temperatures not higher than 100° C.) and an excellent rigidity at room temperature. At the end of the hot processing, the starting rigidity of the formulate must be reacquired in relatively short times. The use of a polychloroprene latex reinforced with Polystyrene or high-styrene SBR as described in the present invention, used for this type of application, is much better than a latex with polychloroprene alone or a possible mechanical mixture with a high styrene SBR latex; the products prepared according to the present invention in fact obtain a good compromise between the final rigidity of the end-product, a good hot processability and rapid recovery of the rigidity during the cooling. The evaluations were effected by measuring the rigidity with a Lorentzen & Wettre apparatus. The end-product impregnated with the latex to be tested, was thermally treated and the rigidity was measured at established times until it returned to the initial value.

The following examples are provided for a better understanding of the present invention.

### EXAMPLES

Method for determining the rigidity of the latex with a Lorentzen & Wettre apparatus:

Prepare a mixture with the quantities specified in Table 1 and impregnate a cotton felt having dimensions of 32 cm×21 cm.

TABLE 1

| Ingredients | Pure parts |
|---|---|
| Latex* | 100 |
| ZnO | 5 |
| CaCO₃ | 30 |
| Hexamethaphospate | 0.5 |

*Latex with 30% of solid

After one minute, pass the impregnated felt to a Foularda Mathis apparatus at a pressure of 0.6 Kg/cm² in order to obtain the desired quantity (500-550 gr/m²), then dry it in an air circulation oven at 140° C. for 5 minutes. Remove the felt from the oven and leave it in a thermostatic chamber at 23° C. and 50% relative humidity for at least 24 hours. Cut two samples from opposite ends of the felt with a suitable hand punch having dimensions of 15 mm×38.1 mm, then measure the thickness. Measure the rigidity with the Lorentzen & Wettre apparatus set at a folding angle of 10°, folding angle distance and blade lever of 25 mm. Put the samples in an air circulation oven at 100° C. for 5 minutes, transfer it to the thermostatic chamber and after 5 minutes measure the rigidity, and subsequently every 10 minutes, measure the rigidity. The test is considered completed after at least 12 hours of measuring. The results are expressed as a rigidity index (N) by the following formula:

$$N = \frac{( B F / 1000 ) * 60 * {L}^{2} / ( 3.14 * A * H )}{S}$$

wherein N rigidity index in N; BF=arithmetic average obtained from the values provided by the instrument expressed in mN; L=curvature length (25 mm); A=curvature angle (10 degrees); H=height of the test-sample (38.1 mm); S=thickness of the test-sample in mm.

The recovery trend of the rigidity index is obtained by graphically indicating the values in relation to the cooling time of the test-samples. The higher the recovery of the rigidity, the better the sample evaluated. The presence of styrene in the composite particles increases the rigidity index with respect to the polymer consisting of polychloroprene alone. This index is much higher for polymers prepared using emulsions of polystyrene alone. For this type of application, it has been observed that rigidity indexes higher than 12 N in the first 5 minutes of cooling of the end-product, make it difficult to process. It is possible to use polystyrene as reinforcing latex of polychloroprene according to the present invention, but preferably in a quantity not higher than 15-209 of the final composite polymer. The percentage can be increased on the other hand, using high-styrene SBR latexes in which the polymer has a Tg higher than the Tf of polychloroprene but lower than polystyrene. The rigidity recovery trend is substantially analogous both for products prepared according to the present invention and for products of polychloroprene alone under the same polymerization conditions for the chloroprene monomer, demonstrating that there are no significant alterations in the characteristics of the polychloroprene (crystallinity and crystallization rate). There is a different behaviour, on the contrary, on the part of the mechanical mixture of the latex which has an excessive initial rigidity, but above all a rigidity recovery considered insufficient, and consequently its use is held to be disadvantageous. It has been observed that with the use of a high-styrene SBR latex, it is possible to obtain a good compromise between final rigidity of the end-product, rapid recovery of the rigidity and a good hot processability, with much higher performances than polychloroprene alone.

In the applicative field of adhesives for the gluing of Cotton/Cotton and SBR/SBR, a high thermal holding temperature is important. The use of a latex reinforced with Polystyrene or high-styrene SBR as described in the present invention is considerably improved with respect to a latex with polychloroprene alone or its possible mechanical mixture with an high-styrene SBR latex.

The products prepared according to the present invention have, in fact, maintained good adhesive capacities, equal to those of polychloroprene latexes, providing however an excellent thermal holding temperature to the glued end-product. The evaluations were carried out in an oven at an increasing temperature by subjecting test-samples, glued with the latex to be tested, to stretching, until detachment.

Preparation method of the test-samples:

Cut strips of cotton having dimensions of 2×15 cm, and pass two layers of latex. After 10 minutes of drying, pass a third layer of latex and leave the strips to dry for 15 minutes.

Divide the strips into pairs and pass them three times in a press for 30 seconds at a pressure of 6 Bars.

The SBR test-samples are glued as follows:

Deposit a layer of latex having a thickness of 0.35 mm, with the help of an applicator.

Divide the test-samples into pairs and dry them at room temperature.

Evaluation method of the glue:

The adhesion strength was evaluated in peeling tests at room temperature, according to the regulation ISO 868, 1 hour, 48 hours and 7 days after the preparation of the test-samples.

The thermal holding temperature was, on the other hand, measured by subjecting the test-samples to constant stretching under the following conditions:

Hang the test-samples, three at a time, onto an arm, in an oven at an established increasing temperature of 2° C./min.

Hang onto the second arm a weight of 500 grams and register the elongation over a period of time.

Register, on a diagram, the peeling length in relation to the temperature until detachment.

Mark the tangents at the initial and end points of the curve; the intersection of the two tangents corresponds to the thermal holding temperature.

### Example 1

1 a) Polymerization of the first step

1668 g of water, 6.5 g of sodium carbonate, 93 g of potassium oleate (aqueous solution at 8.5%), 16 g of Daxad 16 (condensation product of naphthalene sulfonic acid with formic aldehyde solution at 45%), 88 g of styrene, were charged into a 5 litre polymerization reactor. The mixture was stirred at 300 rpm under nitrogen and heated to 70° C. 205 g of potassium persulfate (aqueous solution at 3%) were added, at this temperature. After 1 hour of reaction, the temperature was brought to 90° C. The following products were then fed to the reactor over a period of 6 hours: 1515 g of styrene; 72 g of Daxad 16; 374 g of potassium oleate (aqueous solution at 8.5%); 125 g of potassium persulfate (aqueous solution at 3%). At the end of the 6 hours of feeding, the Polystyrene latex remained at a constant temperature for 2 hours, and was subsequently cooled and filtered.

1 b) Polymerization of the second step

651 g of latex prepared as described in Example 1 a), 1545 g of chloroprene, 338 g of water and 1.8 g of n-dodecyl mercaptan, were charged into a 5 litre polymerization reactor. The mixture was stirred at 300 rpm under nitrogen and cooled to 10° C. The following products were fed to the reactor, at this temperature, over a period of 12 hours: 623 g of potassium resinate (aqueous solution at 15%), 80 g of sodium dithionite (aqueous solution at 2%) and 90 g of sodium persulfate (aqueous solution at 2%). The reaction was interrupted at 98% of conversion by the introduction of a solution of phenothiazine. The non-reacted monomer was removed by steam distillation at reduced pressure. The composite particles of final latex have a polystyrene content of 15% and a polychloroprene content of 85%. The final latex was formulated according to the quantities of Table 1. The evaluations of the rigidity index after 5 minutes and with time are indicated in Table 2 and in Graph 1.

### Example 2

2 a) Polymerization of the first step

1668 g of water, 6.5 g of sodium carbonate, 93 g of potassium oleate (aqueous solution at 8.5%), 16 g of Daxad 16, 89.6 g of styrene, 0.02 g of t-dodecyl mercaptan and 12.7 g of butadiene, were charged into a 5 litre polymerization reactor. The mixture was stirred at 300 rpm under nitrogen and heated to 70° C. 205 g of potassium persulfate (aqueous solution at 3%) were added, at this temperature. After 1 hour of reaction, the temperature was brought to 90° C. The following products were then fed to the reactor over a period of 6 hours: 1539 g of styrene; 219 g of butadiene; 0.38 g of t-dodecyl mercaptan; 374 g of potassium oleate (aqueous solution at 8.5%); 86 g of Daxad 16; 125 g of potassium persulfate (aqueous solution at 3%). At the end of the 6 hours of feeding, the latex remained at a constant temperature for 2 hours, and was subsequently cooled and filtered. The copolymer obtained has a styrene/butadiene composition of 82.5/17.5 (high-styrene SBR) 2 b) Polymerization of the second step

651 g of latex prepared as described in Example 2 a), 1545 g of chloroprene, 960 g of water and 1.8 g of n-dodecyl mercaptan, were charged into a 5 litre polymerization reactor. The mixture was stirred at 300 rpm under nitrogen and cooled to 10° C. The following products were fed to the reactor, at this temperature, over a period of 12 hours: 316 g of potassium resinate (aqueous solution at 15%), 95 g of sodium dithionite (aqueous solution at 2%) and 103 g of sodium persulfate (aqueous solution at 2%). The reaction was interrupted at 98% of conversion by the introduction of a solution of phenothiazine. The non-reacted monomer was removed by steam distillation at reduced pressure. The final particles have a content of high-styrene SBR prepared in Example 2 a) of 10% and a polychloroprene content of 90%. The final latex was formulated according to the quantities of Table 1. The evaluations of the rigidity index after 5 minutes and with time are indicated in Table 2 and in Graph 2.

### Example 3

3 a) Polymerization of the first step

As per Example 2 a)

3 b) Polymerization of the second step

651 g of latex prepared as described in Example 3 a), 1754 g of chloroprene, 465 g of water and 2.04 g of n-dodecyl, mercaptan, were charged into a 5 litre polymerization reactor. The mixture was stirred at 300 rpm under nitrogen and cooled to 10° C. The following products were fed to the reactor, at this temperature, over a period of 12 hours: 707 g of potassium resinate (aqueous solution at 8%), 83 g of sodium dithionite (aqueous solution at 2%) and 90 g of sodium persulfate (aqueous solution at 2%). The reaction was interrupted at 98% conversion by the introduction of a solution of phenothiazine. The non-reacted monomer was removed by steam distillation at reduced pressure. The final particles have a content of high-styrene SBR prepared in Example 3 a) of 15% and a polychloroprene content of 85%. The final latex was formulated according to the quantities of Table 1. The evaluations of the rigidity index after 5 minutes and with time are indicated in Table 2 and in Graph 2.

### Comparative Example 1

1838 g of chloroprene, 623 g of water and 2.04 g of n-dodecyl mercaptan, 755 g of potassium resinate (aqueous solution at 8%) and 12 g of DNMS (aqueous solution at 45%) were charged into a 5 litre polymerization reactor. The mixture was stirred at 300 rpm under nitrogen and cooled to 10° C. When this temperature had been reached, the following products were fed to the reactor over a period of 10 hours: 65 g of sodium dithionite (aqueous solution at 2%) and 70 g of sodium persulfate (aqueous solution at 2%). The reaction was interrupted at 98% conversion by the introduction of a solution of phenothiazine. The non-reacted monomer was removed by steam distillation at reduced pressure. The final latex was formulated according to the quantities of Table 1. The evaluations of the rigidity index after 5 minutes and with time are indicated in Table 2 and in Graph 1.

### Comparative Example 2

Mechanical blend of two latexes consisting of 85 parts of the polymer prepared in Comparative example 1; containing 15 parts of the polymer prepared in Example 1 a). The final latex was formulated according to the quantities of Table 1. The evaluations of the rigidity index after 5 minutes and with time are indicated in Table 2 and in Graph 1.

### Example 4

4 a) Polymerization of the first step

As per Example 2 a).

4 b) Polymerization of the second step

As per Example 2 b) but the polymerization was carried out at conversion>99%.

The thermal holding temperature evaluations are indicated in Table 3.

### Example 5

5 a) Polymerization of the first step

As per Example 2 a).

5 b) Polymerization of the second step

As per Example 2 b) but the polymerization was interrupted at 90% conversion.

The thermal holding temperature evaluations are indicated in Table 3.

### Example 6

6 a) Polymerization of the first step

As per Example 2 a).

6 b) Polymerization of the second step

As per Example 2 but the polymerization was interrupted at 70% conversion.

The thermal holding temperature ealuations are indicated in Table 3.

### Comparative Example 3

Mechanical blend of two latexes consisting of 90 parts of the polymer prepared in Comparative example 1 containing 10 parts of the polymer prepared in Example 2 a). The thermal holding temperature evaluations are indicated in Table 3 .

### Comparative Example 4

As per Comparative example 1 but at a conversion of 70%.

The thermal holding temperature evaluations are indicated in Table 3.

### Comparative Example 5

As per Comparative example 1 but at a conversion greater than 99%.

The thermal holding temperature evaluations are indicated in Table 3.

TABLE 2

| | Examples | | | Comparative Examples | |
|---|---|---|---|---|---|
| | 1 | 2 | 3 | 1 | 2 mech- |
| | (a)/ | (a)/ | (a)/ | homo- | anical |
| | (b) | (b) | (b) | polymer | mixture |
| STY/BDE | 100/0 | 82.5/17.5 | 82.5/17.5 | — | — |
| (phr) | | | | | |
| Polymer a) % | 15 | 10 | 15 | 0 | 15 |
| CP (phr) | 100 | 100 | 100 | — | — |
| Polymer b) % | 85 | 90 | 85 | 100 | 85 |
| Polym. T ° C. | 10 | 10 | 10 | 10 | — |
| Conversion % | 98 | 98 | 98 | 98 | — |
| Rigidity index | 11.3* | 6 | 8.5 | 4.1 | 14.8* |
| 5 minutes (N) | | | | | |
| Final rigidity | 24.9 | 21.8 | 23.3 | 15.1 | 13 |
| index (N) | | | | | |

*For rigidities after 5 minutes higher than 12 N, the end-product is not processable.

The table indicates the rigidity indexes after 5 minutes of cooling and the final rigidities of the pieces of felt treated with: the latexes prepared according to the present invention (Examples 1, 2 and 3); polychloroprene homopolymer latex (Comparative example 1); latex of mechanical mixture of polychloroprene with polystyrene (Comparative example 2). The comparative examples have much lower final rigidities with respect to the examples of the invention. The final rigidity tends to be higher for Example 1, where the polychloroprene is reinforced with 15% of polystyrene, whereas with the same composition as polymer a), it tends to become higher, the higher the ratio between polymer a)/polymer b). The behaviour of Comparative example 2 is extremely poor, in that it has an excessive rigidity after 5 minutes of cooling which remains almost unaltered until the end of the evaluation. Whereas Example 1 has a rigidity index after 5 minutes at the limit of processability, Examples 2 and 3 have a much higher index than Comparative Example 1, providing a good compromise between processability and final rigidity, above all excellent for Example 2 containing 15% of high-styrene SBR.

TABLE 3

| | Examples | | | Comparative Examples | | |
|---|---|---|---|---|---|---|
| | 4 | 5 | 6 | 3 mech- | 4 | 5 |
| | (a)/ | (a)/ | (a)/ | anical | homo- | homo- |
| | (b) | (b) | (b) | mixture | polymer | polymer |
| STY/BDE | 82.5/17.5 | 82.5/17.5 | 82.5/17.5 | — | — | — |
| (phr) | | | | | | |
| Polymer a) % | 10 | 10 | 10 | 10 | 0 | 0 |
| CP (phr) | 100 | 100 | 100 | — | — | — |
| Polymer b) % | 90 | 90 | 90 | 90 | 100 | 100 |
| Polym. T | 10° C. | 10° C. | 10° C. | — | 10° C. | 10° C. |
| Conversion % | >99 | 85 | 70 | — | 70 | >99 |
| Gel (%) | 71/2 | 6/45 | 3/20 | not | 0/20 | 75/0 |
| Macro/micro | | | | determined | | |
| Thermal holding | 102 | 87 | 86 | not | 57 | 72 |
| temp. | | | | determinable | | |
| (° C.) | | | | | | |

Adhesion strength(kg/cm) on different supports

| | | | | | | |
|---|---|---|---|---|---|---|
| Cotton/Cotton | | | | | | |
| 1 hour at 23° C. | 3.3 | 3.9 | 4.0 | <0.1 | 3.9 | 3.2 |
| 48 hours at | 4.7 | 4.2 | 4.2 | <0.1 | 4.2 | 4.6 |
| 23° C. | | | | | | |
| SBR/SBR | | | | | | |
| 1 hour at 23° C. | 1.3 | 1.6 | 1.7 | <0.1 | 1.7 | 1.3 |
| 48 hours at | 1.4 | 2.0 | 2.3 | <0.1 | 2.2 | 1.3 |
| 23° C. | | | | | | |

The table indicates the evaluations of cotton/cotton and SBR/SBR adhesion in relation to the conversion for: the latexes prepared according to the present invention (Examples 4, 5 and 6); the latexes of polychloroprene alone (Comparative examples 4 and 5); the mechanical mixture of polychloroprene latex with high-styrene SBR latex (Comparative example 3). The latter was the only one which did not provide an acceptable adhesion strength on the two supports, all the other latexes gave an almost equivalent adhesion strength regardless of the latex sample. The latexes prepared according to the present invention (Examples 4, 5 and 6) prepared both at a low and high polymeric conversion, provided a much higher thermal holding temperature with respect to the latexes of Comparative examples 4 and 5 of polychloroprene homopolymer.

With an increase in the conversion, the thermal holding temperature tends to increase until 102° C. is reached (Example 4) with respect to the 72° C. of Comparative example 5.

Graph 1 indicates the trend of the rigidity index in relation to the cooling time of the felt treated with: the latex prepared according to the present invention with 15% of polystyrene (Example 1); the latex of polychloroprene homopolymer (Comparative example 1); the mechanical mixture of polychloroprene latex 85% and polystyrene latex 15% (Comparative example 2). The rigidity trend of the mechanical mixture (Comparative example 2). is extremely poor and totally different from the others, indicating that the sample is rigid right from the beginning and does not recover further rigidity during the cooling. The trends of the latex of Example 1 compared with Comparative example 1, on the other hand, are substantially identical, demonstrating that there is no alteration in the characteristics of poly-chloroprene.

Graph 2 indicates the rigidity index trend in relation to the cooling time of the felt treated with: the latex prepared according to the present invention with 10% of high-styrene SBR (Example 2); the latex prepared according to the present invention with 15% of high-styrene SBR (Example 3); the latex of polychloroprene homopolymer (Comparative example 1). The rigidity index trend during the cooling time is substantially analogous for all three latexes, demonstrating that the present invention does not alter the characteristics of polychloroprene. The latexes prepared according to the present invention however have a higher rigidity than the polychloroprene homopolymer. On increasing the percentage of high-styrene SBR in the final composite latex (Example 3, 15% of SBR), the rigidity of the felt treated also increases.

1. Use of aqueous latexes prepared according to a process which comprises:
a) a first radicalic polymerization step in aqueous emulsion of a polymerizable composition essentially consisting of styrene or a mixture of styrene and 1,3-butadiene, to which a maximum of 10% of chloroprene is optionally added, thus obtaining a first latex;
b) a second radicalic polymerization step in aqueous emulsion which consists in polymerising, on the latex obtained in step (a), chloroprene or mixtures of chloroprene and monomers copolymerizable with chloroprene, the latter in a quantity not higher than 10% by weight with respect to the chloroprene, in the preparation of reinforcement for footwear or in the preparation of adhesives.

2. Use according to claim 1, characterised in that the content of styrene in the styrene/1,3-butadiene mixture ranges from 100% by weight to 30% by weight, preferably from 90% by weight to 60% by weight.

4. The process according to claim 1, characterized in that at the end of step (a) a latex is obtained with a content of solids ranging from 5% by weight to 60% by weight.

5. The process according to claim 1, characterized in that at the end of step (a) a latex is obtained with a content of solids ranging from 30% to 50% by weight.

6. The process according to claim 1, characterized in that the polymeric particles obtained at the end of step (a) have an average diameter ranging from 1 nm to 1000 m.

7. The process according to claim 5, characterized in that the polymeric particles obtained at the end of step (a) have an average diameter ranging from 5 nm to 500 nm.

8. The process according to claim 1, characterized in that in step (a) the conversion of polymerizable monomers ranges from 60% to 100% by weight.

9. The process according to claim 8, characterized in that in step (a) the conversion of polymerizable monomers ranges from 70% to 99% by weight.

10. The process according to claim 1, characterized in that the monomers copolymerizable with chloroprene in step (b) are selected from mono and diethylenic unsaturated monomers and sulfur.

11. The process according to claim 1, characterized in that at the end of step (b) the polymeric particles have a dimension ranging from 50 nm to 1500 nm.

12. The process according to claim 1, characterized in that at the end of step (b) the conversion ranges from 60% to 100% by weight.

13. The process according to claim 11, characterized in that at the end of step (b) the conversion ranges from 70% to 99% by weight.

14. The process according, to claim 1, characterized in that at the end of step (b) the latex has a content of solids ranging from 25% by weight to 65% by weight.

15. The process according to claim 13, characterized in that at the end of step (b) the latex has a content of solids ranging from 45% by weight to 60% by weight.

16. The process according to claim 1, characterized in that at the end of step (b) the latex has a content of gel ranging from 5% to 90% by weight.

17. The process according to claim 1, characterized in that step (b) is carried out using a preformed latex.

18. Use of the latexes prepared according to claim 1, in the preparation of reinforcements for footwear.

19. Use of the latexes prepared according to claim 1, in the preparation of adhesives.
